(19) United States
(12) Patent Application Publication
(10) Pub. No.: US 2007/0256976 A1
(43) Pub. Date: Nov. 8, 2007

(54) Metal-coated sorbents as a separation medium for HPLC of phosphorus-containing materials

(76) Inventors: Barry E. Boyes, Wilmington, DE (US); James D. Martoscllo, Downingtown, PA (US); Susanne C. Moyer, Newark, DE (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/401,577

(22) Filed: Apr. 10, 2006

(51) Int. Cl. C02F 1/44

(52) U.S. Cl. 210/639

(57) ABSTRACT

Methods for the separation of biological materials from a sample mixture are provided, using a support comprising metal coated onto a sorbent matrix. Methods using the support as a chromatographic column for separation are provided. The present disclosure also provides methods for making the metal-coated sorbent support.

### REFERENCE TO RELATED APPLICATIONS

This application is a nonprovisional application and is related to, and claims priority to, copending U.S. nonprovisional applications Ser. Nos. [not yet known], filed evendate herewith and entitled “Titanium-coated Sorbents as Separation Medium for HPLC of Phosphorus-containing Materials,” and “Metal-coated Superficially Porous Supports as Medium for HPLC of Phosphorus-containing Materials,” the disclosures of which are incorporated herein by reference in their entirety.

### BACKGROUND

Interest in proteomics analysis has increased dramatically over the past several years. The biological systems used in proteomics analysis are often very complex, containing mixtures of different chemical compounds present at different concentrations, such as proteins. Of particular interest are phosphorylated proteins, which play an important role in cell signaling. Therefore, effective isolation, detection and separation of such compounds are necessary. Multi-dimensional separation techniques such as liquid chromatography, including high-performance liquid chromatography (HPLC), are typically used for such separations.

Immobilized metal affinity chromatography (IMAC) has been used for the selective binding of proteins, as explained in Porath et al., A New Approach to Protein Fractionation, Nature, 258: 598-599 (1975). This technique is based on interaction between an electron-donating group on a protein surface, and a metal cation with one or more accessible coordination sites. The metal ion, in turn, is attached to a metal-chelating groups attached to a solid matrix or support.

The ligands used in IMAC are usually tri-, tetra-, or pentadentate, providing metal chelation to the ligand bound on the solid support, while maintaining additional free sites for coordination of the metal with the analyte. For example, a widely used form of IMAC used Ni(II)-chelated ligand for the selection and purification of His-tagged proteins. Here, Ni²⁺ coordinates with imidazole on the histidine side chain, allowing for purification of recombinant proteins with a His-6 tag.

Techniques that exploit coordination of a particular metal with a specified functional group have been described, although methods using the simultaneous binding of metal to ligand and metal to analyte have proved more elusive. In a typical IMAC experiment, metal ions are loaded onto a chelating solid support, followed by contact with the sample mixture, resulting in binding of the target analyte (such as a phosphopeptide) to the metal ion. Changes in pH affect the electron donor-acceptor properties of the analyte and the metal. For example, with phosphorylated compounds, binding of phosphorylated compounds to the solid support occurs at very low pH (typically <3.5). However, even at low pH values, interference from other charged groups such as the carboxylic acid moieties of aspartic and glutamic acid residues is possible. As the pH is lowered, the ligand that coordinates the metal becomes protonated, and therefore, the negative charge used to non-covalently coordinate the ligand with the positive charge on the metal is eliminated. This causes a loss of the metal chelated to the solid support and a consequent loss of the ability for the solid support-bound ligand to capture phosphate. If, on the other hand, the pH is increased to avoid protonation of the ligand and preserve phosphate-binding ability, deprotonated carboxylic acid moieties (pKₐ˜3.5) also bind to the metal, reducing the utility of the metal-coordinated solid support for selective separation of phosphorus-containing proteins. Problems with metal ion dissociation from the chelating solid support and its subsequent contamination of the separated biological product have also been observed in IMAC. In addition, many IMAC metals that would preferentially coordinate with phosphorylated compounds are insoluble and therefore, it is difficult to load such metal ions onto the chelating solid support.

### SUMMARY

The present disclosure relates to methods for separating biological materials, including materials such as proteins, polypeptides, polynucleotides, phosphopeptides, their chemical or synthetic equivalents, or combinations thereof, from a sample mixture. In embodiments, the disclosure provides methods for separating a target biological material from a sample, using a solid support comprising a sorbent matrix coated with a metal.

In an embodiment, this disclosure provides a method for separating target biological materials from a sample mixture containing one or more biological components. The sample mixture is contacted with the metal-coated sorbent and the target material is captured on the support, or in the pass-through fraction. The selectivity of the metal-coated sorbent for a particular biological material can be varied by altering the pH during separation. The selectivity of the support for a particular biological material can also be controlled by varying the metal used to coat the sorbent matrix.

Methods for the preparation of a metal-coated sorbent support are also described herein. A metal for coating is selected based on the affinity of the metal for the target biological material. The sorbent matrix is then coated with the metal, by covalent or non-covalent means, to form the metal-coated support.

### DETAILED DESCRIPTION

Various embodiments of the present disclosure will be described in detail. Reference to various embodiments does not limit the scope of the claims attached hereto. Additionally, any examples set forth in this specification are not intended to be limiting and merely set forth some of the many possible embodiments of the claims.

Unless defined otherwise, all technical and scientific terms used herein have the same meaning as commonly understood by one of ordinary skill in the art. Although any methods and materials similar or equivalent to those described herein can also be used in the practice or testing of the present disclosure, the methods and materials are now described. Methods recited herein may be carried out in any order that is logically possible, in addition to a particular order disclosed.

In this specification and the appended claims, the singular forms “a,” “an,” and “the” include plural reference, unless the context clearly dictates otherwise. Unless defined otherwise, all technical and scientific terms used herein have the same meaning as commonly understood too one of ordinary skill in the art.

Metal-Coated Supports

The present description is directed to a metal-coated support material where a metal is incorporated onto a sorbent particle. The metal-coated support has high affinity for a particular type of biological material. The metal-coated supports are stable over a wide range of pH values.

The sorbent particle or sorbent matrix is any particle or matrix that can take up and hold a metal, and is stable under conditions used for applying the metal coating. In an embodiment, the sorbent surface is reactive or derivatized for coating with metal. In a further embodiment, suitable materials for the sorbent include alumina, silica, polymers, carbon, zirconium, controlled pore glass, diatomaceous earth, or combinations thereof. In certain embodiments, the sorbent particle is suitable for use as a support in chromatography. In an embodiment, the sorbent particle is part of a support used for chromatography. For the purposes of this disclosure, the term “sorbent” refers to a type of chromatographic support material, and the terms “sorbent” and “support” are used interchangeably herein.

The shape of the sorbent particle is not critical and is determined by application. Suitable shapes include, but are not limited to spheres, ellipsoids, rings, polyhedra, saddles, platelets, fibers, hollow tubes, rods and cylinders. Sorbent particles with regular geometry are generally compatible with chromatographic applications. In an aspect, the sorbent particle has a spherical shape, but geometric perfection of the spherical shape is not critical.

The metal is applied on the sorbent particle through either covalent or non-covalent interactions, including but not limited to electrostatic, ionic, adsorptive, absorptive, and chemical methods. In various embodiments, the metal is applied by coating or claddding, using chemical, physical and/or electrical deposition (adsorption or absorption), welding, grafting, fusing, sintering, or combinations thereof. In an embodiment, the metal is applied in one or more process steps. In a further embodiment, the processes may use intermediate metallic and non-metallic chemical compounds or agents to achieve the metal coating. In various embodiments, the metal is incorporated into, onto, and/or throughout the matrix of a sorbent particle. The terms “coating” and “coated” refer to the covering of the sorbent by metal and include incorporation of the metal either into, or onto, the sorbent. Coating can be accomplished by any of the methods discussed herein. The term “cladding” refers to the formation of a layer of metal on the surface of the sorbent matrix. For the purposes of this disclosure, the terms “cladding” and “coating” are used interchangeably. For the purposes of this disclosure, the terms “cladding” and “coating” exclude cladding or coating by coordination of a metal ion to ligand. In an embodiment, the metal coating consists of an outer monolayer of metal. In another embodiment, the coating consists of multilayers. An example of a method for coating a particular sorbent is taught by Gushikem et al., J. Braz. Chem. Soc. 12: 695-705 (2001); Tan et al., J. Catal. 129: 447-56 (1991), and Choi et al., App. Surf. Sci. 240: 7-12 (2005), the disclosures of which are incorporated by reference herein.

The metal-coated supports have an average particle diameter of about 2 to about 50 μm, for example, 5 μm. In one embodiment, the support comprises coated silica particles with an average particle diameter of about 3 to about 10 μm.

In certain embodiments, the metal-coated supports have pores, the size of the pores being selected to suit the desired biological material to be separated from the sample. In one aspect, the average pore size is greater than or equal to about 300 Å. For example, a support used for the separation of larger biological molecules like proteins would require a pore size larger than 200 Å. In other aspects, the pore sizes of the stationary phase may be less than 300 Å. For example, smaller molecules like drug molecules can be separated using supports with pore sizes in the 40-100 Å range.

The metal-coated support may be used in any of a variety of configurations and techniques. The metal-coated support is suitable for use in a variety of separation techniques, including but not limited to liquid chromatography. Examples of suitable configurations include columns, spin devices, membranes, semi-permeable membranes, beds, molecular sieves, powders, granulates, and fibers.

In various embodiments, the metal-coated supports are incorporated into various configurations, including chromatography columns, filters, membranes, spin devices, or free flowing powders. In one embodiment, the support is used as the stationary phase in liquid chromatography. In a further embodiment, the support is selective for the capture and binding of phosphorus-containing compounds, in liquid chromatography experiments. In one aspect, when used as a column packing material, the support shows improved analyte binding kinetics and efficiency when compared to IMAC stationary phases with analogous particle characteristics.

A sample is typically any mixture of biological material including, but not limited to, proteins, nucleotides, and their modified and/or processed forms. The sample can be derived from biological fluid (such as blood, plasma, serum, urine, tears, etc., for example). The sample can also be obtained from a variety of sources including, without limitation, cell samples, organisms, subcellular fractions, etc. In one aspect, the biological material is a phosphorus-containing compound, including, without limitation, phosphoric esters, phosphates, phosphonates, phosphoric anhydrides, phosphodienes, nucleoside triphosphate analogs, phosphoric amides, fluorophosphoric acids, etc. In another aspect, the biological material is a phosphorylated compound, i.e. a chemical compound to which a phosphate group has been added by the action of an enzyme such as a phosphorylase or a kinase. Phosphorylated compounds include, without limitation, proteins, polypeptides, phosphopeptides, lipids, glycans, nucleotides, polynucleotides, small molecule drugs that mimic nucleotides or polynucleotides, etc.

Methods for Coating Metal onto a Sorbent

In embodiments, the metal of interest is coated onto the sorbent by adsorption and/or absorption techniques. In an aspect, the metal is directly adsorbed and/or absorbed onto the surface of the sorbent, with no intermediate compounds lying between the metal layer and the surface of the sorbent, and no intermediate compounds used to coordinate the metal to the sorbent. In an embodiment, the deposition of metal such as titanium on the sorbent occurs by cladding, welding, fusing, or grafting, of the metal. Incorporation of this type may be accomplished by, for example, electrochemical deposition of the metal. In another aspect, the metal may be incorporated onto the sorbent surface through vapor deposition. In yet another aspect, the metal can be incorporated onto the sorbent by impregnation of the support with a metal salt, followed by hydrolysis and calcination. For example, a process for coating silica with a thin layer of metal oxide for use as a catalytic support is taught in Tan et al., J. Catal. 129: 447-56 (1991). Grafting of metal oxide thin films onto silica for use in HPLC has also been reported by Silva et al., J. Chromatography A. 845: 417-422 (1999).

In a further embodiment, the metal of interest is incorporated onto the sorbent by a sol-gel process. In an embodiment, a thin monolayer of metal is permanently deposited onto the sorbent without altering the morphology or characteristics of the support. In one aspect, nearly linear or branched soluble oligomers (or sols) of metal alkoxides are combined with the sorbents by dipping or spinning to form the metal-coated support. The amorphous metal films formed in this way can be annealed at low temperature to produce dense and crystalline monolayers of metal on the sorbent surface. The sol-gel coating process provides reproducible compositions and coatings with reproducible thickness.

Methods for Separation of Biological Material Using Metal-Coated Sorbents

The disclosure herein provides methods for separation of a target biological material, such as a phosphorus-containing biological material, for example, using a metal-coated sorbent. The metal-coated sorbent is contacted with the sample mixture to capture the target biological material on the support. By “target biological material” is meant the specific biological material to be separated from the sample mixture. In an embodiment, the metal coating on the sorbent can be varied based on the affinity of a given metal for the target biological material. Methods for the selection of a particular metal for the specific binding of an analyte possessing a target functional group are known to those of skill in the art, and generally follow the guidelines described by Pearson et al., Hard and Soft Acids and Bases, J. Am. Chem. Soc., 85: 3533-3539 (1963). Under the HSAB theory, many metal ions can be classified as either hard or soft Lewis acids. The strongest bonds are formed between hard acids and hard bases, or soft acids and soft bases. For example, compounds containing oxygen (e.g. carboxylate), or phosphorus (e.g. phosphorylated proteins or nucleotides) are classified as hard bases and show greatest affinity for metal ions like Ca²⁺, Al³⁺, Ga³⁺, Mg²⁺, Zr⁴⁺ and Fe³⁺, which are classified as hard acids. Transition metal ions like Ni²⁺, Zn²⁺, etc. are known as borderline Lewis acids and have greater affinity for borderline and soft Lewis bases. Various metals may, in theory, be used as selection media. For example, with phosphorylated compounds, the negatively charged phosphate group acts as an electron-donating Lewis base that can bind to coordination sites on a multivalent metal cation.

In embodiments, the metal coating for the sorbent is chosen so as to be available for interactions with phosphorylated compounds. In an embodiment, the metal coating on the sorbent is chosen based on its affinity for the target biological material being separated. In an aspect, the sorbent is coated with Ni(II) metal for the selection of His-tagged proteins. In another embodiment, the sorbent is coated with Pt(II) metal for the selection of sulfur-containing compounds, such as cysteine moieties. Similarly, a coating of Ce(IV) can be used for the selection of phospholipids.

In an embodiment, the pH at which the separation is performed can be varied. In one aspect, the pH range can be adjusted to optimize binding of the target material to the metal-coated sorbent, while minimizing binding of contaminants or non-target components of the sample mixture. The target material captured on the support can be further separated by standard elution procedures. In another aspect, the pH is varied such that the target material is not bound to the support, but instead is collected in the pass-through fraction. In such cases, elution is not required in order to separate the material from the metal-coated sorbent.

In embodiments, the methods described herein are used for the separation of phosphorylated materials. In an aspect, the pH range can be adjusted to optimize phosphate binding to the metal-coated sorbent, while minimizing carboxylic acid binding (from aspartic and glutamic acid residues), as a way of separating phosphorylated compounds. Unlike IMAC, the metal remains attached to the sorbent support at all pH values. In an embodiment, separation is carried out in the pH range of approximately 1-3, which is suitable for capturing phosphorylated compounds on the metal-coated support.

In embodiments, the pH can be modified to a desired value using a buffer, appropriately pH-adjusted. Buffers systems are known and generally include one or more basic compounds and their conjugate acids, such as sodium acetate, or with the addition of acids, such as acetic acid and trifluoroacetic acid. Other example buffer systems include, but are not limited to, maleate, glycine, citrate, formate, succinate, and acetate.

Biological material captured on the surface of the metal-coated support can then be separated from the support using standard elution procedures and techniques known to those of skill in the art. In an aspect, the elution removes the biological material without affecting either the metal coating, or the sorbent. The metal coating remains bound to the sorbent during the elution process. Elution of phosphorylated compounds from the solid support can be accomplished using buffers, such as those containing phosphate salts or ammonium hydroxide.

Phosphorus-containing compounds separated using the support can be detected and/or quantitated and/or further characterized to determine their properties (e.g., amino acid sequence, mass/charge ratio, etc). In one aspect, separated proteins or peptides can be analyzed by a proteomics analysis method, such as, for example, two-dimensional gel electrophoresis. In another aspect, separated proteins can be analyzed by mass spectrometry methods including, but not limited to, MALDI-TOF MS, ESI, TOF, ion trap MS, ion trap/TOF MS, quadrupole mass spectrometry, FT-MS, fast atomic bombardment (FAB), plasma desorption (PD), thermospray (TS), magnetic sector mass spectrometry, etc. The separated proteins or peptides may also be analyzed by NMR and other techniques. The separated proteins or peptides may be analyzed collectively, or individually, to identify proteins.

In embodiments, prior to separation on the metal-coated support, the sample can be contacted with an immunoaffinity stationary phase to enrich the sample with one or more types of protein or protein fragments. In other aspects, proteins may also be contacted with a cleaving agent such as, for example, trypsin, to generate peptides. The cleaving step may also be carried out after separation on the support.

The various embodiments described above are provided by way of illustration only and should not be construed to limit the claims. Those skilled in the art will readily recognize various modifications and changes that may be made to the present methods without following the example embodiments and applications illustrated and described herein, and without departing from the true spirit and scope of the present claims.

1. A method for separating a target desired biological material from a sample, comprising:
contacting the sample to a support comprising a metal-coated sorbent matrix; and
capturing the target biological material on the support; or
collecting the target biological material in the pass-through fraction.

2. The method of claim 1, wherein capturing the biological material on the support further comprises varying the pH to promote binding of the biological material to the support.

3. The method of claim 1, wherein the support is part of a column, spin tube, coated membrane, or powder.

4. The method of claim 1, wherein the sample comprises one or more or lipids, amino acids, nucleic acids, proteins, nucleotides, nucleosides, sugars, oligosaccharides, or mixtures thereof.

5. A method for separating one or more target biological materials from a sample mixture, comprising:
contacting the sample to a support comprising a metal-coated sorbent matrix; and
capturing one or more target biological materials on the support; or
collecting one or more target biological materials in the pass-through fraction,
wherein one or more target materials are captured on the support or collected in the pass-through fraction, but other components of the sample mixture are not captured or collected.

6. The method of claim 5, wherein capturing one or more target biological materials on the support further comprises varying the pH to promote binding of the target biological materials to the support.

7. The method of claim 5, wherein the target biological material comprises one or more of a lipid, amino acid, peptide, protein, sugar, or oligosaccharide present in a sample mixture.

8. The method of claim 5, wherein the target biological material comprises a phosphopeptide.

9. A method for preparing a support for selective separation of a desired biological material from a sample, comprising the steps of:
providing a sorbent matrix;
selecting a metal for binding the desired biological material from a sample based on the affinity of the metal for the desired biological material; and
coating the sorbent matrix with the selected metal to form the support.

10. The method of claim 9, wherein the coating of the metal on the sorbent matrix is by covalent methods.

11. The method of claim 9, wherein the coating of the metal on the sorbent matrix is by non-covalent methods.

12. The method of claim 9, wherein the sorbent matrix comprises silica.

13. The method of claim 9, wherein the metal on the sorbent matrix is selected from the group consisting of Ni(II), Pt(II), and Ce(IV).
